(19) United States
(12) Patent Application Publication
(10) Pub. No.: US 2009/0216621 A1
(43) Pub. Date: Aug. 27, 2009

(54) Media Based Entertainment Service

(76) Inventors: Andrew T. Anderson, Los Gatos, CA (US); Benjamin Silva, III, Freemont, CA (US); Michael A. Catalano, Los Gatos, CA (US); Mitchell Louis Berman, Menlo Park, CA (US)

Correspondence Address: CARR & FERRELL LLP, 2200 GENG ROAD, PALO ALTO, CA, 94303, US

(21) Appl. No.: 12/390,308

(22) Filed: Feb. 20, 2009

Related U.S. Application Data
(60) Provisional application No. 61/066,814, filed on Feb. 22, 2008.

(51) Int. Cl. G06Q 30/00; G06Q 99/00

(52) U.S. Cl. 705/10; 705/14; 705/30; 705/26

(57) ABSTRACT

A media based entertainment service provides user requested media to a user. Video, audio, images and other media may be provided to a user for a fee or free of charge. The media may be provided from the service provider to a client device over a network. When providing media without charge, the media service can incorporate one or more ads into the media. The ads may be targeted to the user, media content, and other features using advertisement parameters. The media service provides for revenue generation associated with the viewing of media files. The media service can generate revenue from advertising, pay-per-view, e-commerce, and other financial transactions associated with the media service while focusing on providing the service on user preferences.

### PRIORITY CLAIM TO RELATED APPLICATION

This application claims the priority benefit of U.S. provisional patent application No. 61/066,814, filed Feb. 22, 2008, the disclosure of which is incorporated herein by reference.

### BACKGROUND

Traditional media content providers such as television broadcasters and internet networks provide content on behalf of an artist, author, or production house. In some systems, an intermediary acquires content from the content provider and often negotiates with an intermediary broadcaster or network provider who then negotiates with resellers and advertisers based on content provided by the network or system. Acquired content and associated advertising is typically pushed to a group of users via channels controlled by the intermediary or network service provider. The advertising is typically chosen to match the content, content popularity, and/or user groups thought to view such content. This is commonly known as the push model.

Some systems allow a user to choose specific items of content. For example, internet-based services allow a user to choose a desired song to be downloaded from the internet and/or order a desired movie or TV show for viewing. Such systems typically require the a priori knowledge of which item of content is desired. For example, a user may wish to choose from among thousands of movies, thousands of TV shows, hundreds of thousands of songs, millions of web pages, or other large numbers of media items. This is commonly known as the pull model.

Existing systems that push media content provide a limited system for delivering content to a user in an efficient and cost-effective manner, do not provide the advertiser with a cost effective manner, or a manner by which the advertiser can verify with certainty, that a user, or group of users has actually viewed the ad, nor can the advertiser target specific users, or user groups, based on a set of parameters, or allow the users to determine themselves which advertisements they want to view, and as a result cost the user, advertisers and media service partners time and money.

### SUMMARY

The technology described herein pertains to an interactive media based entertainment service that provides user requested media and products to a user and in addition may recommend non-user requested interactive media and offers that match user preferences and viewing usage behavior patterns. Video, audio, images and other media may be provided to a user for a fee or free of charge, or any combination of both. The media may be provided from the service provider to a client device over a network. When providing media without charge, the media service can incorporate one or more ads into, surrounding or near the media. The ads may be targeted to the user, media content, and other features using advertisement parameters. Traditional ads are supported, and two-way interactive capability is provided in the form of interactive advertisements, promotions, surveys, polls or rewards offered from the media itself, the ads, the user interface or the program guide. All advertisements described herein may be interactive or non-interactive and may include an offer for more information, or the option to Buy Now.

In some embodiments, advertisements and offers may be provided to a user through an advertisement video user interface, or the program guide. The video user interface includes ads that correspond to user preferences and usage and have ad parameters which the user specifies or that satisfies the users preferences or which advertisements they prefer to view. Advertisements and offers provided to a user through the media service can include information for purchasing a product associated with the ad. At any time during playback of an advertisement or offer, the user may initiate and complete a purchase of goods or services associated with the provided advertisement, or request more information from the advertiser, or provide additional details requested by the advertiser in the form of responding to an interactive survey or poll related to the advertisement or offer.

An embodiment of the technology can receive user click, hover (duration on offers or frequency of re-play) and playback data by a server from a client device associated with a user, where the user playback click or hover data is associated with user playback events associated with user playback of advertisements and requested media. The server can receive a media content request by the server from the client device and receive media content and media meta-data associated with the media request. The server can select one or more advertisements or offers to incorporate with or within the media content, where the advertisements or offers are selected based on user data, or requests for such advertisements are made directly from the user, playback data and advertisement parameters. The server provides the media and incorporated advertisements or offers to the requesting client device without adjusting a user account balance associated with the client device. The server can transfer a portion of the advertisement revenue associated with the advertisements to a content provider associated with the media content. The media service can reward the viewer or user for watching requested media content, including video on demand content and advertisements, upon completion of the user viewing the media. In essence the viewer or user is rewarded by the service provider, as a direct result of the viewer or user watching the ad.

In some embodiments, consumers can have different relationships with entities in communication with the media service. For example, a consumer can provide adverstisement content as an advertiser, media content as a producer, or sell goods and services, and make offers regarding those goods and services, as a merchant.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an exemplary system for providing an entertainment service to a user.

FIG. 2 is a block diagram of revenue relationships for a media service.

FIG. 3 is a flow chart of an exemplary method for providing a media service.

FIG. 4 is a flow chart of an exemplary method for providing requested media to a client device.

FIG. 5 is a flow chart of an exemplary method for facilitating a purchase request.

FIG. 6 is a flow chart of an exemplary method for collecting user playback data.

FIG. 7 is a flow chart of an exemplary method for processing and storing user media service data.

FIG. 8 is a block diagram of an exemplary computing device for implementing the present technology.

### DETAILED DESCRIPTION

An interactive media based entertainment service provides a user with media that is automatically delivered and requested by the user. Video, audio, images and other media may be provided or offered to a user for a fee or free of charge. Goods and services may also be offered to a user. Entertainment may be requested explicitly by selecting from a range of choices, or by searching, or received passively (if the user sets this preference). The content will be delivered based on system recommendations that closely match the user's preferences and usage patterns or behavior. The media may be provided from the service provider to a client device over a network. When providing media without charge, the media service can incorporate one or more ads into the media. The ads and offers may be targeted to the user, media content, requested by the user, and other features using advertisement parameters.

In some embodiments, advertisements may be provided to a user through the user interface. The user interface includes ads that correspond to user preferences and behavior and have ad parameters which the user satisfies. Advertisements provided to a user through the media service can include information for purchasing a product associated with the ad. At any time during playback of an advertisement, the user may initiate and complete a purchase of goods or services associated with the provided advertisement.

The media service provides for revenue generation associated with the viewing of media files or interactivity with the service from the user interface or program guide. The media service can generate revenue from advertising, pay-per-view, e-commerce, clicks, hovering, events, other interaction and other financial transactions associated with the media service while focusing on providing the service on user preferences. Revenue may be generated directly from customer/users via pay-per-view (PPV) revenue, subscription fees, and the like.

Revenue may also be generated from advertisers using customer/user information, through an entertainment service, and to provide specific advertising and offers directed to a specific customer/user based on his preferences and/or behavior. In some aspects, this directed advertising may result in higher advertising revenue than with typical media services.

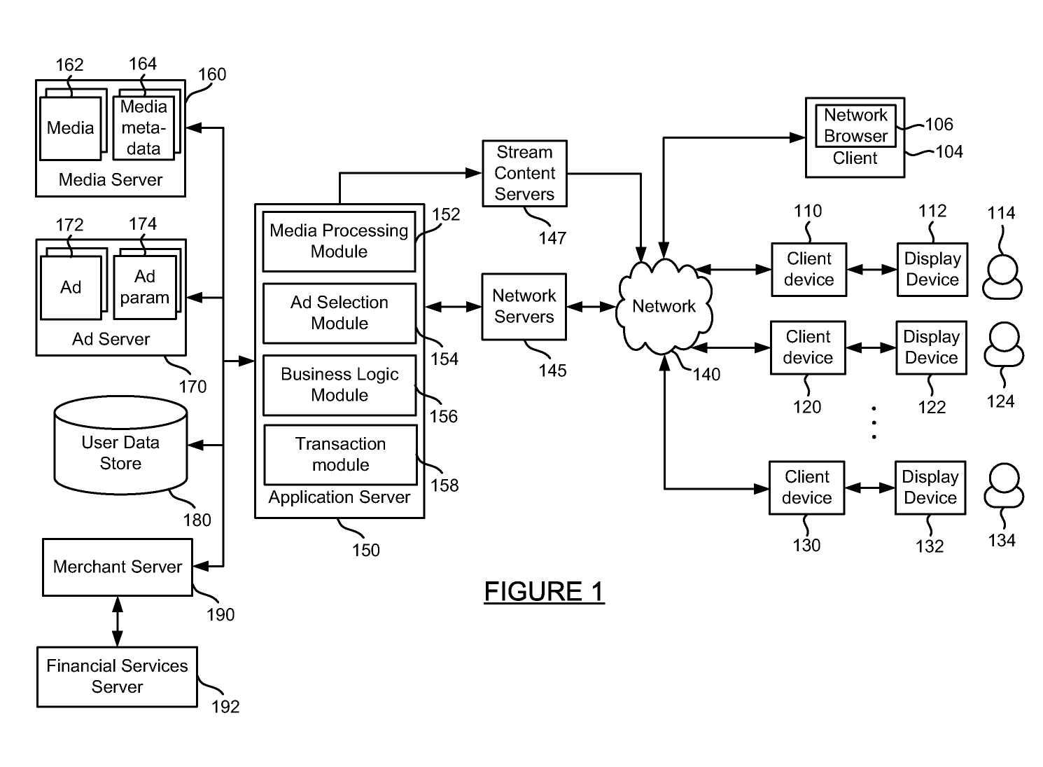

FIG. 1 is a block diagram of an exemplary system for providing an entertainment service to a user. The system of FIG. 1 includes a system of servers in communication with a system of client devices over a network. Client devices 110, 120 and 130 communicate with display devices 112, 122 and 132, respectively. Users 114, 124 and 134 are associated with each display device and client device combination, respectively. For example, a user 114 may provide input to client device 110 to retrieve and playback video content through display device 112. In some embodiments, the media service discussed herein is implemented by application server 150 and network server 145. In some embodiments, the system providing media service can also include any of servers 160-190.

Client 104 is coupled to network 140 and may include network browser 106. Network browser 106 may request, receive and provide network content such as a web page. For example, a user may access a media service provided over network 140 through network browser application 106.

Client devices 110-130 and client 104 are coupled to network 140. In some embodiments, each of client devices 110-130 may be implemented as a set-top box which provide content through a viewer user interface. An exemplary set-top box is disclosed in U.S. patent application Ser. No. 12/360,007, entitled “Set-Top Box,” filed on Jan. 26, 2009, the disclosure of which is incorporated herein by reference. Other devices may embed the technology directly, including but not limited to television sets, mobile devices, gaming consoles, watches, phones, and digital cameras.

Network 140 can facilitate communication between network server 145, client 104 and client devices 110-130. Network 140 may be implemented as the Internet or other WAN, a LAN, intranet, extranet, private network or a combination of networks.

Network server 145 can include one or more servers and communicates with application server 150 and network 140. Network server 145 can be implemented as a web server that operates as an intermediary server between application server 150 and network 140. For example, network server 145 may be a web server or application web server that receives requests from client devices 104, 110, 120 and 130, processes and forwards the requests to application server 150, and sends a response generated by application server 150 to the requesting client device.

Application server 150 communicates with network server 145, can include one or more servers, and includes logic which implements the media service of the present technology. Application server 150 can include media processing module 152, ad selection module 154, business logic module 156 and transaction module 158. Each of the modules 152-158 can be implemented on a different application server or backend server, such as servers 160-190. Other modules and logic may be incorporated on application server in addition to those illustrated in FIG. 1.

Media processing module 152 may receive, encode, and transmit video, audio, images and other media to client devices 104 and 110-130 through network server 145. The media may be transmitted as a complete file, a streaming data such as streaming video, or in some other format. Media processing module 152 may incorporate selected advertisements received from or identified by ad selection module 154 within video media and transmit the video media with the incorporated ads.

Ad selection module 154 may access advertisement media and advertisement parameters from ad server 170. The ad parameters specify how ads can be incorporated into a particular media file by media processing module 152. The parameters can indicate a user gender, geographic location, income level, marriage status, or other user demographic data, as well as user viewing behavior, purchase behavior, and other user data, or the ad may be selected directly by the user. The ad parameters may also specify content categories, brand adjacency, frequency requirements, cost information, and other display rules for providing the an ad to a user.

Business logic module 156 may handle various business logic and processing rules associated with the media service. For example, business logic module 156 may handle user loyalty and reward programs which reward a user for certain viewing behavior and interaction with advertisements. Business logic module 156 may also retrieve and manage user data contained in user data store 180 and determine revenue distribution among different participants in a media service ecosystem, such as users, advertisers, content providers, merchants, network service provider companies (cable companies, power companies, telephone companies, and so forth), and other groups.

Transaction module 158 may facilitate commerce transactions between a client device and merchant server 190. Facilitating a purchase transaction allows a user to purchase goods or service associated with an advertisement through the media service.

Application server 150 may transmit content through stream content servers 147. In some embodiments, stream content servers 147 may include one or more servers configured to stream content to several client devices. For example, stream content servers 147 may include a host stream device which receives media and advertising content. The host stream device may provide content to one or more streaming servers which establish connections with a client device and stream media content, including requested and recommended media as well as advertisements, to the client.

Application server 150 may communicate with media server 160, ad server 170, user data store 180, and merchant server 190. Media server 160 may store media 162 and related information, including metadata 164 for stored media, which may be retrieved by application server 150. Media 162 may comprise movies, TV episodes, offers, and other video, as well as audio and image media, interactive media and application services such as two-way Voice Over Internet Protocol (VOIP) telephony, two-way video and other interactive applications. Media metadata 164 may include information associated with each piece of media or an offer, such as a media category (i.e., sports, documentary, family, and so forth), media length, potential breaks within the media for inserting ads, cost of playback for media, and other data associated with the media.

Ad server 170 can communicate with application server 150 and may include one or more advertisements 172 as well as advertisement parameters 174 associated with each ad. Advertisements 172 may be associated with a company, product, service or some other topic of potential interest for a user. The ad parameters indicate to whom a particular ad should or is required to be provided to, as well as cost information, timing information and other ad requirements. Ad parameters may be configured for an advertisement by an advertiser with preferred and required parameters for matching an ad to a combination of a user data (including user demographic data), media content, and time.

User data store 180 can communicate with application server 150 and data for users having an account with the media service. The user data can include user demographic data, user playback data, user purchase data, and other data associated with a user of the media service. Merchant server 190 handles purchases requested by a user through client device 130. Merchant server 190 may be associated with an e-commerce service, a particular service or product provider, or some other organization. Merchant server 190 may communicate with one or more banks or credit card, credit card processing services, merchant gift cards, pre-paid merchant cards, or other financial services as represented by financial server 192.

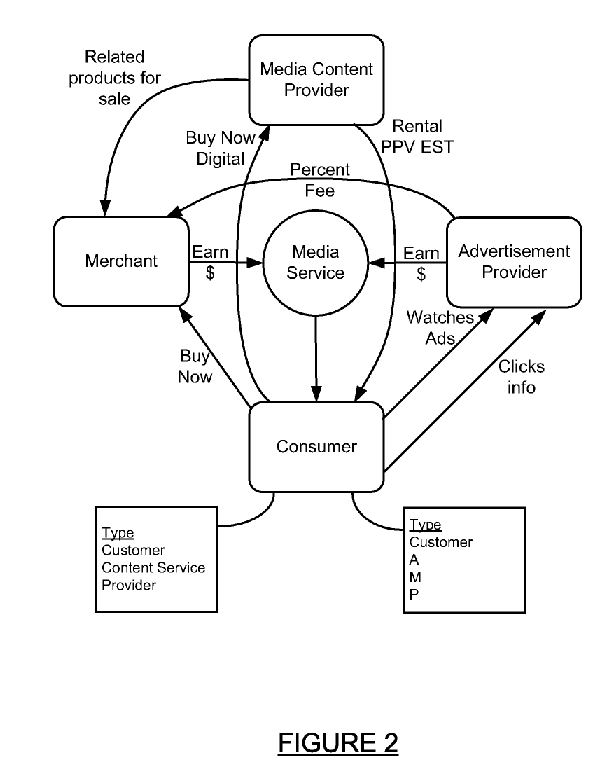

FIG. 2 is a block diagram which illustrates transaction relationships between elements associated with a media service. The media service can have a transactional relationship with a media content provider, advertiser provider, consumer and merchant. A media content provider may provide content to a consumer through the media service, as well as providing information regarding products for sale by a merchant. An advertisement provider may provide ads and target user preferences to the media service, along with revenue based on ads provided to the user by the media service (as well as based on other criteria). A merchant can provide revenue to the media service based on transactions performed by the user through the media service. A consumer can perform purchase transactions with a merchant through the media service, provide buy now input to buy media from the media content provider, and receive requested and offered media (and advertisements, product and service information and other information) from media content provider and advertisement provider through the media service. Consumers of the media service may include a content service provider, a person or entity that subscribes to the media service, merchants, and content producers. Thus, users of the media service can act as content providers, advertisers, or merchants. The different models supported by the system illustrated in FIG. 2 include a peer-to-peer model, an individual one-to-many targeting model, and a group wise targeting model. The media service may implement a system that provides both requested media (via a pull model) and offers suggested media (via a push model) for a user, as well as providing and offering advertisements. A consumer may be rewarded from the media service for receiving or requesting advertisements.

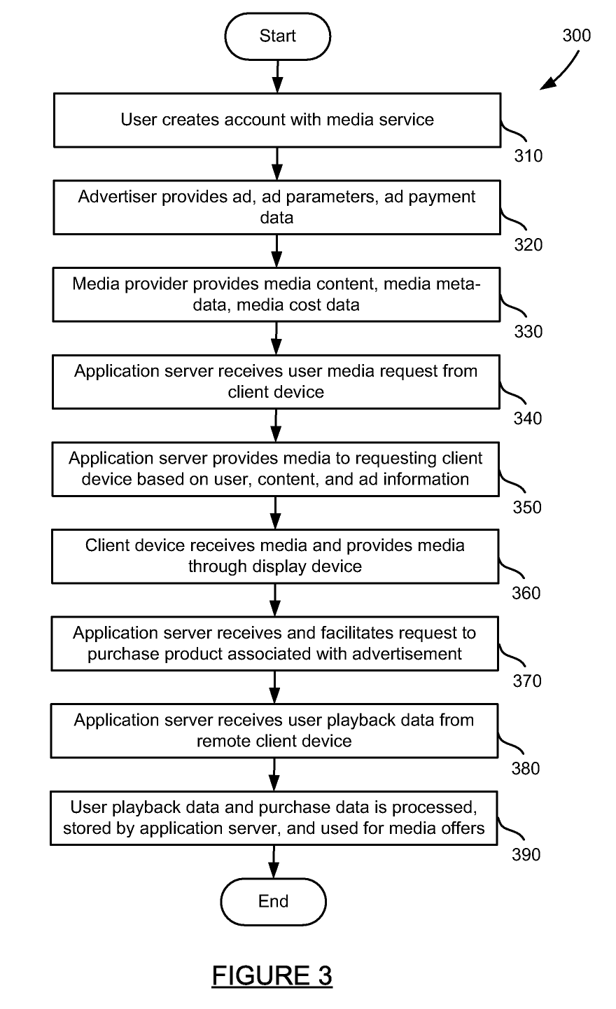

FIG. 3 is a flow chart of an exemplary method for providing a media service. The method of FIG. 3 may be implemented by the media service system of FIG. 1. A user creates an account with the media service at step 310. A user can create an account through a web portal of the media service. The media service web portal may be accessed through network browser 106 on client 104. Creating an account can include providing user identification, payment, media service preferences, advertisement preferences, and other information. In some embodiments, the user pays a subscription fee, enrollment fee, or other fee when creating an account with the media service.

Advertisers may provide ads, ad parameters, and ad payment data to the media service at step 320. The ads may be video, audio, images, animation, or in some other format. The ad parameters may indicate advertiser preferences and requirements for ad time, and other preferences. A media provider can provide media content, media metadata and media cost data to the media service at step 330. The media metadata can include media category data, running length, and other media data. The media data may be provided to application server 150 by media server 160.

Application server 150 receives a user media request from a client device 110 at step 340. As a user engages the media service through client device 110, the user may navigate a series of user interfaces to request media, for example as video-on-demand (VOD). When a user requests media through the interface, client device 110 creates and sends a request to network server 145 for the requested media. Network server 145 receives the request and forwards the request to application server 150. In some embodiments, the request is for media content such as a movie or a television episode. In some embodiments, media requests may be for an advertisement or offer through an user interface, for example a user interface that provides videos and advertisements.

In some embodiments, a user request for media indicates that a user will pay a fee for to view the media. In this case, the media is provided to the user without advertisements. In some embodiments, the user request for media indicates the user does not wish to pay a fee for the media content. Media content may be packaged with other content, goods, services and made available as part of a promotional offer via regular or interactive advertising. In this case, advertisements are selected for the combination of user preferences and behaviors, the user selected content, ad parameters that specify advertiser preferences, and the ad display temporal or geographic constraints. The media service may then collect revenue by showing the ads to the user within the selected media (discussed in more detail below).

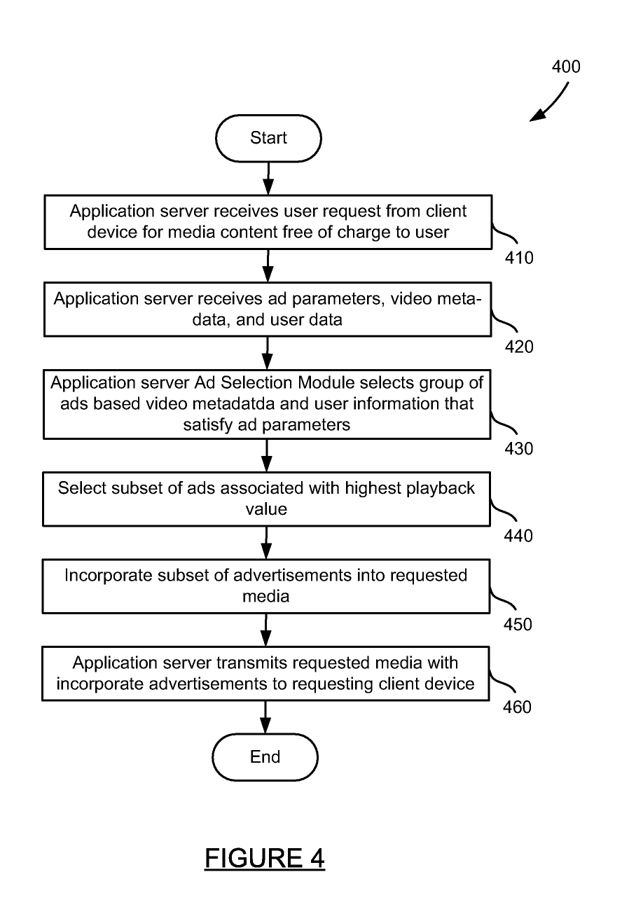

Application server 150 provides the requested media or recommended to the requesting client device at step 350. The media is provided along with advertisements selected based on a user associated with the client device, the requested content, and ad information. The media may include video with one or more advertisements incorporated within or near (pre-roll or post-roll) the video or media. If the request is for an advertisement or an offer, the ad may be provided to the requesting client device as part of a list of ads selected to correspond to a list of user preferences or behaviors. Providing media to a requesting client device by an application server is discussed in more detail below with respect to FIG. 4.

Client device 110 receives the requested media and provides the media through display device 112 at step 360. During playback of the media through display device 112, user 114 may provide input to device 110 to pause, fast forward, rewind, and otherwise control playback of the media. User input to control the media playback as well as media playback status (i.e., played to completion, played 50% complete) is received by client device 110, transmitted to server device 150 and stored at device 180.

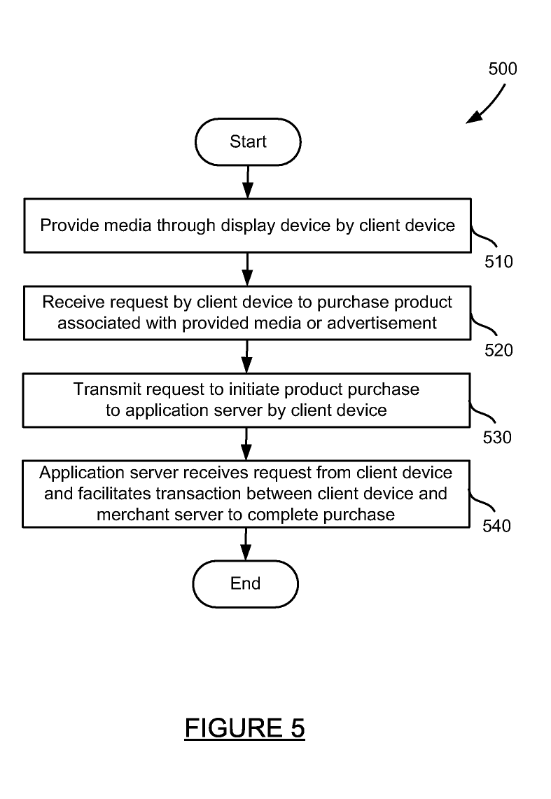

In some embodiments, a user can provide input to purchase an advertised product during playback of the product advertisement. Alternatively, the user may interact with the user interface or program guide, search results, viewing history or recommendations offered by the system to purchase a product whether advertised or not. When received, the client device may forward a purchase request to application server 150. Application server 150 receives and facilitates a request to purchase a product or service associated with an advertisement at step 370. The user may purchase goods or service associated with an advertisement provided to the user. Information associated with the purchase is logged and stored by the media service. Receiving and facilitating a purchase request associated with an advertisement is discussed in more detail below with respect to FIG. 5.

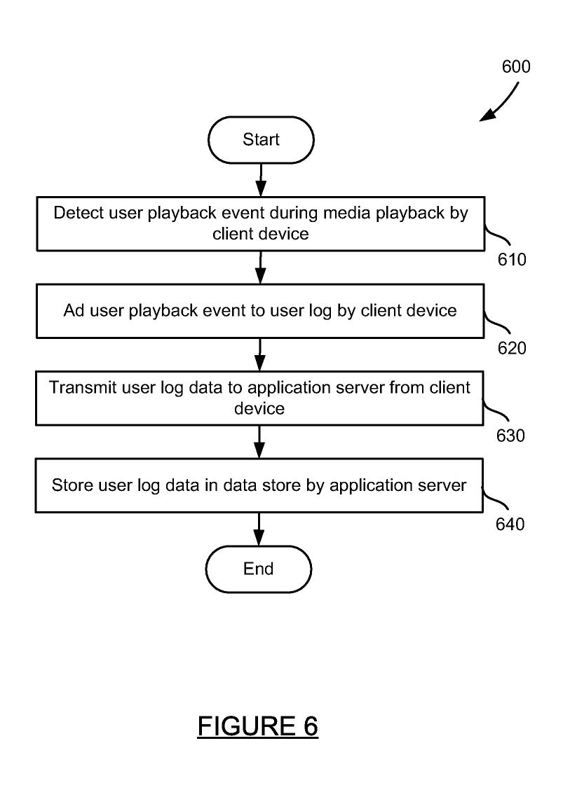

Application server 150 receives user playback data from remote client device 110 at step 380. The playback data can be used to recommend media or provide relevant search results and ads and/or offers to the user in the future. Users may search for all content including ads, offers or programs. Users can build their own playlists by interactively selecting content, searching, or building from a list of recommendations all stored and managed by application server 150. Receiving user playback data is discussed in more detail below with respect to FIG. 6.

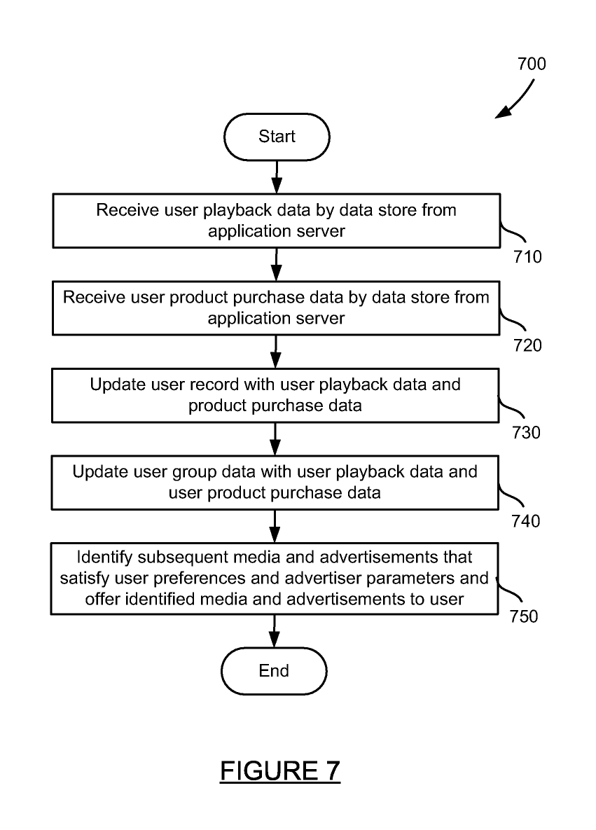

User playback data and purchase data is then stored and processed by application server 150. Processing user playback and purchase data may include updating a user record with the data, as well as updating data associated with groups or buckets of users. The stored user data may be use to target subsequent ads, offers and recommendations to the particular user. Processing and storing this data is discussed in more detail below with respect to FIG. 7.

FIG. 4 is a flow chart of an exemplary method for providing requested media to a client device. In some embodiments, the method of FIG. 4 provides more details for step 350 of the method of FIG. 3. Application server 150 receives a user request from client device 110 for the media content at no charge at step 410. The request if transmitted by client device 110 to network server 145 over network 140. Network server 145 receives the request and forwards the request to application server 150. Application server 150 then receives ad parameters, media metadata and user data at step 420. This data will be used to select one or more ads or programs to include within or near the requested media content in order to provide the content to a user at no charge.

Application server 150 can select a group of ads based on media metadata and user information that satisfies ad parameters at step 430. Ad selection module 154 may select a group of ads for which the requesting user and media requested satisfy the ad parameters for the corresponding advertisement.

A subset of ads or offers is selected from the group of ads which have the highest playback value to the media service at step 440. The set of ads selected in step 430 may each have a different value upon playback. In some embodiments, the value of the ads may be normalized to a common context, for example cost per thousand view (CPM) and sorted based on CPM value. The highest value ads are then selected and sorted into a playback list. Exceptions to the value-based selection of ads exist. For example, an ad may be placed in the subset of ads if it must be played in the near future to satisfy a contract obligation to the advertiser, or the ads are directly requested by the user. In addition to traditional CPM revenue, the interactive ads and offers provide revenue in the form of cost per action (CPA) and cost per click (CPC). CPC revenue is derived when a user clicks to receive more information about an advertised product or service. CPA revenue is generated when a user clicks the BUY NOW button on a device to initiate a purchase from the service which then creates an e-commerce transaction. In some embodiments, the transaction is performed through an interactive interface provided through a television, and thus may be considered a television-commerce or t-commerce transaction.

The subset of advertisements and/or offers can be incorporated into the requested media at step 450. In some embodiments, the ads can be placed in slots of a video. Placing the ads within media content is performed by media processing module 152. Media processing module 152 of application server 150 then transmits the requested media with the incorporated ads to the requesting client device 110 at step 460.

As discussed above, ads and/or offers placed in media content may have a certain value per ad. The revenue received for playback of the ads may be shared between several recipients. For example, ad revenue may be shared with the content provider, a network service provider, partner, and other recipients.

FIG. 5 is a flow chart of an exemplary method for facilitating a purchase request. In some embodiments, the method of FIG. 5 provides more details for step 370 of the method of FIG. 3. First, media is provided for playback through display device 112 by client device 110. A request is then received by client device 110 to purchase a product associated with an advertisement and/or offer currently being displayed at step 520. In some embodiments, the request may be received through client device 110 when a user 114 engages a “buy now” button on a remote control which communicates with client device 110.

A purchase request is transmitted by client device 110 to application server 150 to initiate a product purchase. The request can include advertisement and/or offer identification information as well as client device, user, time stamp, and other data. Application server 150 receives the request from client device 110 and facilitates the transaction between client device 100 and merchant server 190 at step 540. Facilitating the transaction includes forwarding the purchase request from client device 110 to merchant server 190. Also communicated to merchant server 190 from application server 150 are user identification information, shipping information, payment information, and other data required for completing the purchase. Merchant server 190 may process the purchase request with financial services server 192 and then confirm purchase completion to client device 110 through application server 150.

Revenue generation for commerce transactions performed through client devices with merchant server 190 may involve referral fees paid to the merchant entity. The merchant may perform e-commerce transactions and receive a transaction fee per transaction. The media service may also charge a transaction fee per transaction.

FIG. 6 is a flow chart of an exemplary method for collecting user playback data. In some embodiments, the method of FIG. 6 provides more details for step 380 of the method of FIG. 3. First, a user playback event is detected during media playback by client device 610. A playback event may include input received by client device 110 from a user, wherein the event affects media playback, a state of the playback (i.e., start, complete), or some other state or action associated with medial playback. A user playback event may be associated with a user action performed during playback of media content, such as play, pause, stop, rewind, fast forward, or some other action performed during playback or from the program guide.

User playback event data for the event is then added to a user log maintained by server device 150. User log data is transmitted to application server 150 from client device 110 at step 630. The user log data transmission may be performed based on several factors. For example, user log data may be transmitted on each use or periodically, such as every hour, every half hour, or at some other time interval. In some embodiments, user log data may be transmitted to application server 150 via network server 145 upon completion of a particular video playback or when the user stops playback of the video. In some embodiments, the user log data may be transferred at some other optimal time based on available user log data and resource usage. After transmitting the user log data, user log data is stored in user data store 180 by application server 150 at step 640. The user log data can be utilized to offer a high level of ad and/or offer targeting to advertisers and merchants.

FIG. 7 is a flow chart of an exemplary method for processing and storing user media service data. In some embodiments, the method of FIG. 7 provides more detail for step 390 of the method of FIG. 3. First, user playback data is received by data store 180 from application server 150. The user playback data is captured and provided as discussed above with respect to the method of FIG. 6. User purchase data is also received by data store 180 from application server 150. User purchase data is captured and provided as part of the method of FIG. 5. The user record is updated with user playback and product purchase data at step 730. The user record may indicate how often a user completes a purchase transaction, initiates a purchase transaction, the number of videos within different categories that are viewed by the user, and other data.

User group data may be updated with user playback data and user product purchase data at step 740. In some embodiments, data for server users may be grouped in order to expedite processing of user data when determining which ads and/or offers to associate and incorporate into or near a particular media selection. For example, a list may be maintained for a group of users which enjoy action movies. In this case, if the received user playback data was associated with an action movie, the user group data may be updated to indicate that the user which just finished the action movie should be included in that user group.

Subsequent media and advertisements that satisfy user preferences, user behavior and advertiser parameters are identified and offered to a user at step 750. Identifying and offering media and advertisements can be performed in response to a user request for media or advertisement and provided as supplemental content, or provided in response to some other user event. The identified content can be provided along with requested content, for example through an interface of suggested content that accompanies a user request. The identified content can also be provided without requested content, for example in an interface that suggests content the user may be interested in. The suggested content offered to a user can include media, advertisements, offers of goods and services for purchase, and other content. In some embodiments, offering content to a user can be performed in subsequent iterations of the method of FIG. 3 as part of step 330, where the offered content is provided along with or in place of requested content.

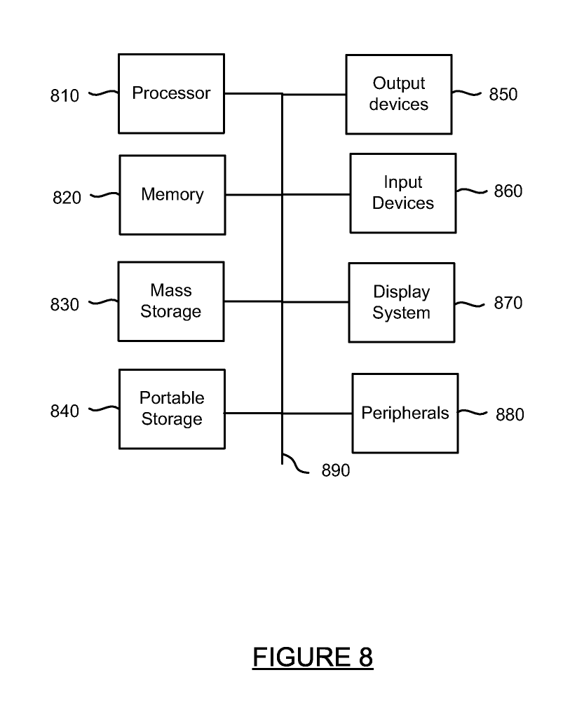

FIG. 8 is a block diagram of an exemplary computing device for implementing an interactive media service environment. In some embodiments, the exemplary computing device of FIG. 8 may be used to implement client devices 104 and 110-130, network server 145, application server 150, media server 160, ad server 170, user data store 180, merchant server 190 and financial services server 192.

The computing system 800 of FIG. 8 includes one or more processors 810 and memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 820.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Examples of suitable output devices include speakers, printers, network interfaces, and monitors.

Display system 870 may include a CRT, a liquid crystal display (LCD) or other suitable display device. Display system 870 receives textual and graphical information, and processes the information for output to the display device.

Peripherals 880 may include any type of computer support device to add additional functionality to the computer system. For example, peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

Revenue generation via a service associated with the viewing of media files is disclosed. Interactive media files may include television shows, movies, on-demand shows, sporting events, concerts, audio files, documentaries, educational programming, and other types of audiovisual displays.

Generally, various embodiments address systems and methods for a multimedia company to generate revenue from advertising, pay-per-view, rental, e-commerce, and other financial transactions. Revenue may be generated directly from customer/users (i.e., viewers of media files) via pay-per-view (PPV) or rental revenue, subscription fees, and the like. Revenue may also be generated directly from customer/users wishing to pay rather than receive advertising, and from a revenue share of purchased goods or services.

Revenue may also be generated from advertisers. In various aspects, advertising revenue may be increased by using customer/user information, through an entertainment system, to provide specific advertising directed to a specific customer/user based on his preferences and/or behavior. In some aspects, this directed advertising may result in higher advertising revenue than with typical broadcast advertising.

Revenue may be generated from customer/users via an on-demand media file service (e.g., like so-called “On-Demand” programming) that allows customer/users to find and watch a selected video program simply, quickly, and efficiently on their entertainment system (e.g., their television set, computer, or combination of the two).

Revenues generated from advertising, pay-per-view, rental, and e-commerce may be shared with content producers/owners, participating network operators, and partners at various negotiated rates.

The service may be delivered via a common household broadband connection that uses (for example) an internet-protocol television (IPTV) set-top box. The IPTV set top box may be free to the customer/user. In other embodiments, access to the service may be via other network types, an imbedded Internet connection or other high speed network in a television or computing device, rendering the need for a set top box moot.

In various embodiments, customer/users watch programs (e.g., television) for free by selecting an advertising campaign of their choice by category, brand, or personal preference. This creates a Personal Advertising Campaign (PAC) for each customer/user, by which directed advertisements may then be inserted at appropriate points in the program. By selecting various advertisements for viewing, the customer/users may earn cash-like “points” or rewards which can be used to purchase consumer products and services on the system. In one example, a customer/user selects the option to receive advertisements related to cooking, home improvement and travel. The customer/user may then receive the targeted advertising or offers that meets with their preference through an entertainment system.

Customer/users may also have the choice of watching media files without advertising by purchasing a movie or other media file on a permanent basis (also known as Electronic Sell Through or EST). In one example, media files purchased on the “EST” basis are placed in a customer/user's personal digital library where he/she can watch them any time. In some aspects, a purchased media file may be watched free of advertising for several viewings or an extended period of time. In addition, customer/users can choose to “rent” a media file (e.g., a movie) using various aspects, which may allow the customer/user to watch the media file for a set period of time or set number of viewings.

Aspects are directed toward creating a simple, intuitive way for a customer/user to easily browse, search for, and view any kind of media file at a time of the customer/user's choosing. In some embodiments, a viewer user interface (VUI) provides an easy and intuitive facility which combines a multidimensional database of media file information with a fast, easy to use customer/user interface.

In various embodiments, the multidimensional database of media information may store parameters characterizing many aspects of the media files. The multidimensional database may include links to the media files or include the media files themselves. The user interface includes an interface between a user and the multidimensional database. The user interface may be viewed on the entertainment system (e.g., via a visual display) and manipulated by a navigation tool (e.g., a remote control) such that the user can navigate through the multidimensional database.

The user interface may provide an interface through which a user can access any type of media file at any time. The user interface uses the multidimensional database of media information for scaling access to many (e.g., hundreds, thousands, or even millions) of media files automatically or on-demand, ultimately providing television viewers with an easy way to search and select what they want to watch, any time they wish. Programs are generally always available, not just for limited periods of time at certain times of the day or week or year.

The user interface may provide the functionality such as providing recommendations of media files based on a customer/user's personal viewing habits, allowing customer/users to personalize and select which advertising campaigns and ads that they prefer to watch, allowing customer/users to choose when the ads appear during the viewing of the media file, allowing customer/users to “rate” various aspects of the media files and advertising in real-time on their viewing device, allowing customer/users to share, recommend and interact with other customer/users via a personal “social network” of friends and family, allowing customer/users to either ask for “more information” or purchase consumer products and services (e-commerce) directly from the viewing device with one or two clicks (e.g., a buy now button), allowing customer/users to earn “points” (e.g., a points and cash rewards program) when customer/users select and watch ads along with the selected media file, which may be akin to “rewarding a user to watch TV”, and allowing customer/users the choice to watch any media file without ads by paying a nominal fee for the selected media file on a “Pay As You Go” or “Pay per View” (PPV) or rental basis, instead.

Having found a media file for viewing, the customer/user may also choose options for advertising. A customer/user may choose to receive random advertisements, or, alternatively, a customer/user may choose to receive advertisements by genre, category or directed toward customer preferences or viewing history or a combination of each. Examples of customer preferences include, but are not limited to, timing, duration, and frequency of advertising. In some aspects, a customer/user may choose to pay for watching programs rather than receive advertising. In other aspects, a customer/user may receive rewards points in exchange for viewing advertising.

Various aspects provide for secure and/or encrypted e-commerce transactions, and in some cases, these transactions enable a customer/user to purchase an article associated with a media file being viewed. In one example, a customer/user watching a “James Bond” movie wish to learn about, or even purchase, a watch worn by the actor playing James Bond. The customer may identify the watch by manipulating the user interface, ad, offer or program guide via the navigation tool, and then select a “BUY NOW” button within the user interface.

Various aspects are directed toward securing a financial transaction with a vendor of a product, the customer/user buying the product, and, optionally, a financial institution (e.g., a credit-card company) that manages the back office part of the merchant credit card transaction itself. In some examples, the transaction may be encrypted and/or supported through SSL and other banking industry-standard application level security and fraud protection measures.

Various aspects include the monitoring of customer/user behavior during the searching for, selection of, and viewing of media files. Data related to monitoring may be combined with customer/user-generated preference information. In some aspects, this data may be gathered by using the identification of a set-top box or other hardware associated with the customer/user. This data combined with the preference information may be used to provide direction for advertising toward that customer/user, and this improved direction may result as increased revenue to the advertiser, the customer/user, as well as intermediaries the provide that functionality.

Thus, various aspects create an enhanced customer/user experience, wherein a customer/user can easily find and choose media files for viewing or receive relevant recommendations and also choose among a diverse set of advertising or offer campaigns. By offering an improved customer/user experience, revenue can be generated directly from customer/user. By offering targeted advertising capability to advertisers, advertising revenue can be increased. Because customer/user have access to a wider variety of diverse content, content producers benefit from better access to content by customer/users, and thus increased revenue from content producers may be generated. Finally, revenue from merchants, particularly those involved in e-commerce, may be generated by enhancing a customer/user's ability to purchase items associated with viewed media.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A computer implemented method for processing media requests from a user, comprising:
receiving user playback data by a server from a client device associated with a user, the user playback data associated with user playback events associated with user playback of advertisements and requested media;
receiving a media content request by the server from the client device;
receiving media content and media meta-data associated with the media request;
selecting one or more advertisements to incorporate with the media content, the advertisements selected based on user playback data and advertisement parameters;
providing the media and incorporated advertisements to the requesting client device without adjusting a user account balance associated with the client device; and
transferring a portion of the advertisement revenue associated with the advertisements to a content provider associated with the media content.

2. The computer implemented method of claim 1, wherein the user playback data is associated with one or more content categories.

3. The computer implemented method of claim 1, further comprising:
providing the requested media and an advertisement associated with the advertisement parameters to the device associated with the user by the server.

4. The computer implemented method of claim 1, further comprising:
determining the highest value advertisements to include in the requested media.

5. The computer implemented method of claim 1, further comprising:
calculating by the server portions of ad revenue to share with a content provider associated with the requested media.

6. The computer implemented method of claim 1, further comprising:
determining the advertisement parameters are satisfied by at least a portion of the media information and user information associated with the user.

7. The computer implemented method of claim 1, further comprising:
identifying media based on a set of user preferences, user behavior, and advertiser preferences; and
providing the identified media to the requesting client device with the requested media.

8. The computer implemented method of claim 1, further comprising:
selecting one or more offers to incorporate with the media content, the one or more offers selected based on user playback data and advertisement parameters; and
providing the selected one or more offers to the requesting client device with the requested media.

9. The computer implemented method of claim 1, further comprising:
receiving a request by the server from the device to purchase a product associated with the advertisement provided to the device; and
facilitating the request to purchase the product by the server.

10. A computer implemented method for providing requested media, comprising:
receiving a request for media content by a server from a device associated with a user;
receiving the requested media from a first data store by the server;
receiving an advertisement, meta-data associated with the advertisement and cost information associated with the advertisement from a second data store by the server;
providing the requested media and the advertisement to the device associated with the user by the server; and
receiving a request by the server from the device to purchase a product associated with the advertisement provided to the device.

11. The computer implemented method of claim 10, further comprising:
determining the highest value advertisements to include in the requested media from a group of advertisements allowed to be incorporated into the media.

12. The computer implemented method of claim 10, wherein the user playback data is associated with one or more content meta-data.

13. The computer implemented method of claim 10, further comprising:
performing a calculation by the server to identify portions of advertisement revenue to share with a content provider associated with the requested media.

14. The computer implemented method of claim 10, further comprising:
determining the advertisement parameters are satisfied by at least a portion of the media information and user information associated with the user.

15. The computer implemented method of claim 10, further comprising:
receiving the requested media, meta-data associated with the media and cost information associated with the media from a first data store by the server.

16. The computer implemented method of claim 10, further comprising:
receiving an advertisement, meta-data associated with the advertisement and cost information associated with the advertisement from a second data store by the server.

17. The computer implemented method of claim 10, further comprising:
receiving a request by the server from the device to purchase a product associated with the advertisement provided to the device; and
facilitating the request to purchase the product by the server.

18. A computer readable storage medium having embodied thereon a program, the program being executable by a processor to perform a method for processing media requests, the method comprising:
receiving user playback data by a server from a client device associated with a user, the user playback data associated with user playback events associated with user playback of advertisements and requested media;
receiving a media content request by the server from the client device;
receiving media content and media meta-data associated with the media request;
selecting one or more advertisements to incorporate with the media content, the advertisements selected based on user playback data and advertisement parameters;
providing the media and incorporated advertisements to the requesting client device without adjusting a user account balance associated with the client device; and
transferring a portion of the advertisement revenue associated with the advertisements to a content provider associated with the media content.

19. The computer readable storage medium of claim 1, wherein the user playback data is associated with one or more content categories.

20. The computer readable storage medium of claim 1, further comprising:
providing the requested media and an advertisement associated with the advertisement parameters to the device associated with the user by the server.

21. The computer implemented method of claim 1, further comprising:
determining the highest value advertisements to include in the requested media.

22. A system for providing video content to one or more remote devices, comprising:
first module in a set of one or more servers configured to receive video content and transmit the video content to one or more remote devices;
a second module in the set of one or more servers configured to identify one or more advertisements to incorporate with the video content before the video content is transmitted to the one or more remote devices, the one or more advertisements associated with advertisement parameters relating to the video content and remote device users; and
a third module in the set of one or more servers configured to receive a product purchase request from a remote device in communication with the set of one or more servers and facilitate a purchase transaction with a remote transaction server.

23. The system of claim 19, wherein the one or more servers are configured to receive user playback data associated with user playback of the video content through a remote device

24. The system of claim 19, further comprising a fourth module in the set of one or more servers configured to allocate revenue sharing with a video content provider.
